(19) United States
(12) Patent Application Publication
(10) Pub. No.: US 2017/0302654 A1
(43) Pub. Date: Oct. 19, 2017

(54) INFORMATION PROCESSOR, METHOD FOR CONTROLLING LOGGING ON, AND NON-TRANSITORY COMPUTER-READABLE RECORDING MEDIUM HAVING STORED THEREIN PROGRAM FOR CONTROLLING LOGGING ON

(71) Applicant: FUJITSU LIMITED, Kawasaki-shi (JP)

(72) Inventor: Eiichi MATSUZAKI, Koto (JP)

(73) Assignee: FUJITSU LIMITED, Kawasaki-shi (JP)

(21) Appl. No.: 15/457,008

(22) Filed: Mar. 13, 2017

(30) Foreign Application Priority Data
Apr. 19, 2016 (JP) 2016-083943

(51) Int. Cl. H04L 29/06

(52) U.S. Cl. CPC H04L 63/0815

(57) ABSTRACT

An information processor includes an authentication processor that authenticates a user during a logging-on process of the user; a confirmer that confirms whether a second information processor that the user has already logged on is present within a predetermined range from the information processor; and an authentication simplifier that simplifies, when the second information processor that the user has already logged on by the user is present, the logging-on process carried out by the authentication processor. This configuration allows the user to abate the load of inputting that the user makes for a logging-on authentication.

### CROSS-REFERENCE TO RELATED APPLICATION

This application is based upon and claims the benefit of priority of the prior Japanese Patent application No. 2016-83943, filed on Apr. 19, 2016, the entire contents of which are incorporated herein by reference.

### FIELD

The embodiment discussed herein is directed to an information processor, a method for controlling logging on, and a non-transitory computer-readable recording medium having stored therein a program for controlling logging on.

### BACKGROUND

In recent years, an individual user owing multiple terminal devices such as Personal Computer (PC), a tablet terminal, and a smartphone is not rare.

To prohibit others from using these terminals without any permission of the owner, the terminals are set to undergo strict authentication when the user is logging on.

Strict authentication is effectively achieved, for example, by setting a long complicated password or by biometrics authentication with fingerprints, veins, irises, or face. Besides, from the standpoint of ensuring security, effective setting is to make a terminal to be locked when not being operated and be unavailable until a user makes authentication again.
[Patent Literature 1] Japanese Laid-open Patent Publication No. 2006-102948
[Patent Literature 2] Japanese Laid-open Patent Publication No. 2008-226210
[Patent Literature 3] Japanese Laid-open Patent Publication No. 2008-193166
[Patent Literature 4] Japanese Laid-open Patent Publication No. 2009-15501

Here, a traditional method of controlling logging on applied to an information processor has compelled the above strict authentication each time when the user is using a terminal device even if the user is in home where there is no possibility that others uses the terminal without any permission of the user.

Inputting a long complicated password for each use of a terminal device is intricate. Aversing to input a long complicated password for each use of the terminal device, a user may set an easy password or set not to be locked when the terminal is not operated.

The use of biometrics authentication can abate load for authentication as compared with inputting a complicated password, but restrictions in cost and physical size of the authenticating device makes not every terminal device possible to include a biometrics authentication device.

### SUMMARY

According to an aspect of the embodiment, an information processor includes: an authentication processor that authenticates a user during a logging-on process of the user; a confirmer that confirms whether a second information processor that the user has already logged on is present within a predetermined range from the information processor; and an authentication simplifier that simplifies, when the second information processor that the user has already logged on by the user is present, the logging-on process carried out by the authentication processor.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram schematically illustrating an example of the configuration of a computer system according to a first embodiment;

FIG. 2 is a diagram illustrating an example of functional configuration of a logging-on controller in the computer system of the first embodiment;

FIG. 3 is a diagram illustrating an example of device information of the computer system of the first embodiment;

FIG. 4 is a diagram illustrating an example of connection state managing information of the computer system of the first embodiment;

FIG. 5 is a diagram illustrating an example of a process performed by a logging-on user confirmer of the computer system of the first embodiment;

FIG. 6 is a diagram illustrating example of a process performed by the logging-on user confirmer of the computer system of the first embodiment;

FIG. 7 is a diagram illustrating an example of a logging-on screen in the information processor of the first embodiment;

FIG. 8 is a diagram illustrating an example of a process performed by an authentication processor of the computer system of the first embodiment;

FIG. 9 is a diagram illustrating a modification to the process performed by an authentication processor of the computer system of the first embodiment;

FIG. 10 is a diagram illustrating an example of an easy logging-on screen of the computer system of the first embodiment;

FIG. 11 is a diagram illustrating another example of an easy logging-on screen of the computer system of the first embodiment;

FIG. 12 is a diagram illustrating an example of information about a user being logging on, the information being managed by a user logging-on status manager of the computer system of the first embodiment;

FIG. 13 is a flow diagram illustrating a succession of procedural steps of searching a near information processor by a searcher of the computer system of the first embodiment;

FIG. 14 is a flow diagram illustrating a succession of procedural steps performed by a method of controlling logging on when the information processor is started in the computer system of the first embodiment;

FIG. 15 is a diagram illustrating an example a logging-on screen that displaying a list of icons representing users allowed to log on in the computer system of the first embodiment;

FIG. 16 is a flow diagram illustrating a first modification to a succession of procedural steps of controlling logging on when the information processor is started in the computer system of the first embodiment;

FIG. 17 is a flow diagram illustrating a second modification to a succession of procedural steps of controlling logging on when the information processor is started in the computer system of the first embodiment;

FIG. 18 is a diagram illustrating a list representing users allowed for easy logging-on in the second modification to the computer system of the first embodiment.

### DESCRIPTION OF EMBODIMENT(S)

Hereinafter, an information processor, a method for controlling logging on, and a non-transitory computer-readable recording medium having stored therein a program for controlling logging on according to a first embodiment will now be detailed with reference to accompanying drawings. The following first embodiment is exemplary and has no intention to exclude various modifications and applications of techniques not referred in the first embodiment. In other words, various changes and modifications (e.g., a combination of the embodiment and the modifications) can be suggested without departing from the spirit of the first embodiment. The drawings do not illustrate therein all the functions and elements included in the embodiment and may include additional functions and elements to those illustrated in the accompanying drawings.

### (A) Configuration

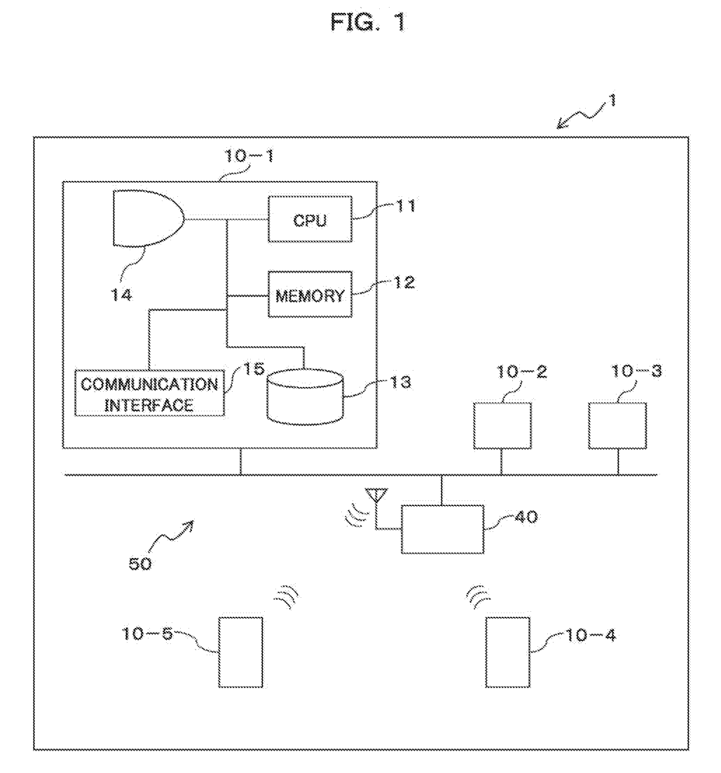

FIG. 1 is a diagram schematically illustrating the configuration of a computer system according to a first embodiment.

The computer system 1 of FIG. 1 includes multiple (five in the example of FIG. 1) information processors 10-1 to 10-5 and is disposed in, for example, the home of the user.

The information processors 10-1 to 10-5 are communicably connected to one another via a network 50.

For example, the information processors 10-1 and 10-3 are wiredly connected to a non-illustrated router via Local Area Network (LAN) cables.

The network 50 includes a wireless router 40, and the information processor 10-4 and 10-5 are wirelessly connected to the network 50 via the wireless router 40 serving as a wireless Access Point (AP).

The information processors 10-1 to 10-5 are the same in configuration. For the convenience sake, FIG. 1 illustrates the hardware configuration only of the information processor 10-1, and omits the illustration of the hardware configurations of information processors 10-2 to 10-5.

Hereinafter, when one of the multiple information processor needs to be discriminated from the remaining information processors, corresponding one of the reference numbers 10-1 to 10-5 is used while an arbitrary information processor is represented by a reference number 10. An information processor 10 may also be referred to a terminal 10.

As illustrated in FIG. 1, each information processor 10 includes a Central processing unit (CPU) 11, a memory 12, a storage device 13, a display 14, and a communication interface 15.

The storage device 13 stores various pieces of data and is exemplified by a Hard disk drive (HDD), a Solid State Drive (SSD), or a Storage Class Memory (SCM).

The memory 12 is a storing memory including a Read Only Memory (ROM) and a Random Access Memory (RAM).

In the ROM of the memory 12, a software program (a program for controlling logging on) related to controlling of logging on and the data for the program are written. Such a software program in the memory 12 is appropriately read and executed by the CPU 11. The RAM of the memory 12 is used as a primary storing memory or a working memory.

The communication interface 15 provides a communication function to communicate with, for example, another information processor 10 and is exemplified by a LAN card or a wireless LAN communication module. A wireless communication module employing, for example, Bluetooth® is also included in the communication interface 15.

In the example of FIG. 1, the information processors 10-1 to 10-3, which are wiredly connected to the network 50, are each provided with a LAN card serving as the communication interface 15, and on the other hand, the information processors 10-4 and 10-5, which are wirelessly connected to the wireless router 40, are each provided with a wireless LAN module as the communication interface 15.

The CPU 11 is a processor that performs various controls and calculations, and achieves various functions by executing the Operating System (OS) and software stored in, for example, the memory 12. Each information processor 10 may configure a multiprocessor with multiple CPUs 11. The CPU 11 may be replaced with a Micro Processing Unit (MPU), a Digital Signal Processor (DSP), an Application Specific Integrated Circuit (ASIC), a Programmable Logic Device (PLD), or a Field Programmable Gate Array (FPGA). Alternatively, the CPU 11 may be a combination containing at least two of a CPU, an MPU, a DSP, an ASIC, a PLD, and an FPGA.

The CPU 11 of each information processor 10 functions as a logging-on controller 100 to be detailed below by executing the program for controlling logging on.

The program (program for controlling logging on) to achieve the function of the logging-on controller 100 is provided in the form of being stored in a non-transitory computer-readable recording medium such as a flexible disk, a CD (e.g., CD-ROM, CD-R, and CD-RW), a DVD (e.g., DVD-ROM, DVD-RAM, DVD-R, DVD+R, DVD-RW, DVD+RW, and HD DVD), a Blu-ray disk, a magnetic disk, an optical disk, and a magneto-optical disk. The CPU 11 reads the program from the recording medium and forwards the read program to an internal memory device or an external memory device, which stores the program for future use. Alternatively, the program may be stored in, for example, a memory device (recording medium) such as a magnetic disk, an optical disk, and a magneto-optical disk, and may be provided from the memory device to the computer through a communication path.

In achieving the function as the logging-on controller 100, the program stored in the internal memory device (in this embodiment, the RAM or the ROM of the memory 12) is executed by the microprocessor (in this embodiment, the CPU 11) of the computer. Alternatively, the computer may read the program from a recording medium and then execute the read program.

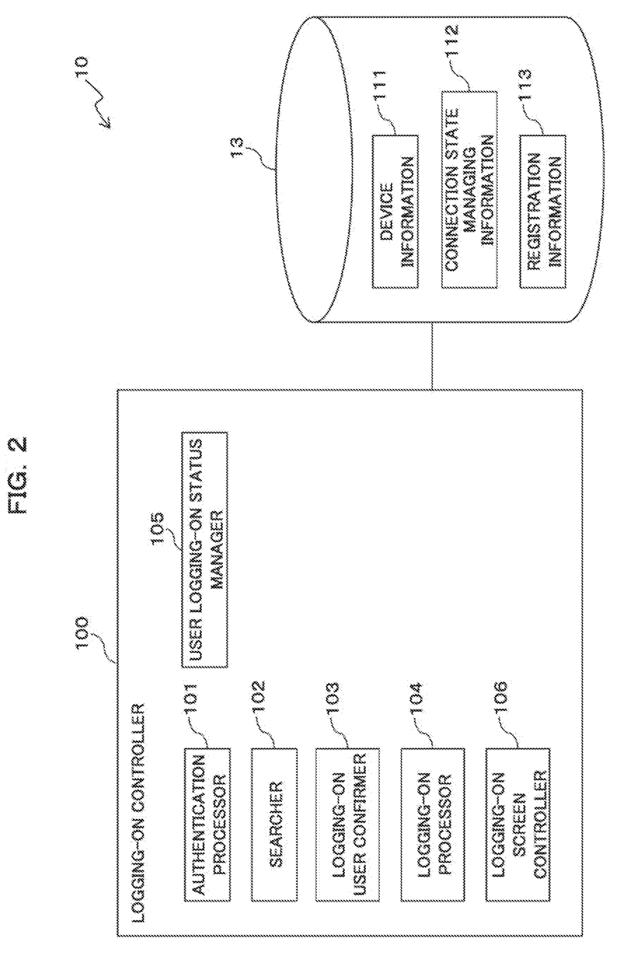

FIG. 2 is a diagram illustrating the functional configuration of the logging-on controller 100 of the computer system 1 according to the first embodiment.

The logging-on controller 100 controls, in the information processor 10, a logging-on process performed to allow the user to use the information processor 10.

As illustrated in FIG. 2, the logging-on controller 100 includes the functions as a authentication processor 101, a searcher 102, a logging-on user confirmer 103, a logging-on processor 104, a logging-on screen controller 106, and a user logging-on status manager 105.

The searcher 102 searches for a near information processor 10 to the local information processor 10. Here, an information processor 10 near to the local information processor 10 is preferable disposed at a distance that can been directly seen from the local information processor 10.

For example, multiple information processors 10 used at a distance that can been seen from one another can be assumed to be used by the same person.

In such a case, if one of the information processors 10 (first information processor 10) has been successfully authenticated to log on, the user that is to use another information processor 10 (second information processor 10) can be assumed to be the same. Accordingly, omitting the authentication to log on for the second information processor 10 causes no problem.

For the above, in the computer system 1, the searcher 102 of the information processor 10 searches for another information processor 10 within a predetermined range centers around the information processor 10 (hereinafter referred to as the local information processor 10) in which the searcher 102 is functioning.

The searcher 102 determines the presence or absence of another information processor 10 by, for example, issuing (outputting) a network managing command (information collecting command) of the OS or using an Application Programming Interface (API) via the network 50. The presence or absence of an information processor 10 on the network 50 can be confirmed by various known manners, detailed description for which is omitted here.

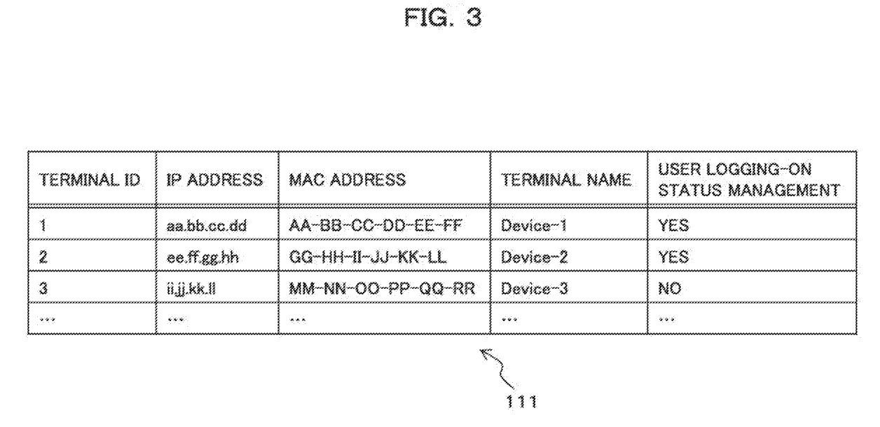

The searcher 102 can collect device information 111 as illustrated in FIG. 3 by confirming the presence or absence of an information processor on the network 50.

FIG. 3 is a diagram illustrating an example of the device information 111 of the computer system of the first embodiment.

The device information 111 is information of each information processor 10 included in the computer system 1. The device information 111 of FIG. 3 contains a terminal Identifier (ID), an Internet Protocol (IP) address, a Media Access Control (MAC) address, a terminal name, and user logging-on status management.

The user logging-on status management represents whether the corresponding information processor 10 is provided with the function as the user logging-on status manager 105 that is to be detailed below. Specifically, this means that the information processor 10 for which “YES” is registered in the field of user logging-on status management has a function as the user logging-on status manager 105. On the other hand, the information processor 10 for which “NO” is registered in the field of user logging-on status management does not have a function as the user logging-on status manager 105.

For example, at the start of the local information processor 10, the logging-on user confirmer 103 that is to be detailed below sends and receives the user logging-on status information to and from another information processor 10 via the network 50. In this event, “YES” is registered in the field of the user logging-on status management for the information processor 10 successfully sent and received the user logging-on status information.

The searcher 102 stores the collected information of the respective information processors 10, as the device information 111, into, for example, the storage device 13.

Each information processor 10 has a function of obtaining the connection state managing information 112 for managing the connection states of the respective information processors 10 included in the computer system 1 and storing the obtained connection state managing information 112 into, for example, the storage device 13.

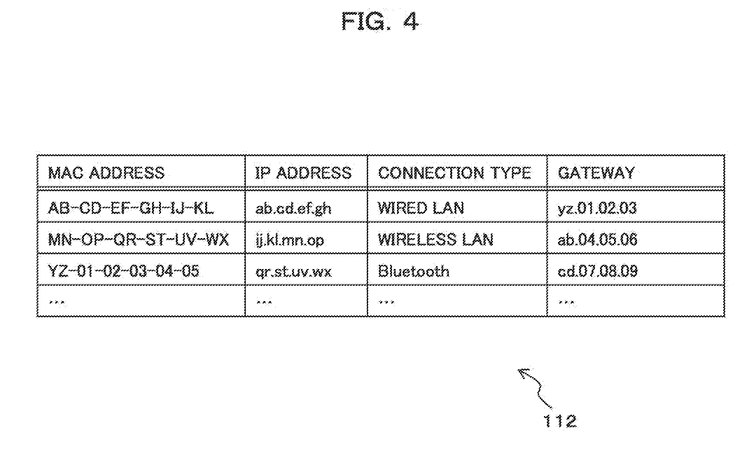

FIG. 4 is a diagram illustrating an example of the connection state managing information 112 of the computer system 1 of the first embodiment.

The connection state managing information 112 illustrated in FIG. 4 includes a MAC address, an IP address, a connection type, and a gateway.

In the example of FIG. 4, one of “wired LAN”, “wireless LAN”, and Bluetooth® is set in the connection type. The gateway represents an address (gateway address) of the gateway used to access the device specified with the corresponding MAC address.

The various pieces of information to be registered in the connection state managing information 112 can be collected in various known manners, the description for which is omitted here.

The various pieces of information registered in the connection state managing information 112 are associated with one another by, for example, using the Plug and Play function of the OS or using information for network management. Alternatively, these pieces of information may be associated by one another by using a database.

The searcher 102 determines whether each information processor 10 registered in the device information 111 is positioned near to the local information processor 10. Hereinafter, an information processor 10 undergoing determination whether being positioned near to the local information processor 10 by the searcher 102 may sometimes be referred to as a determination target information processor 10.

The searcher 102 selects each information processor 10 registered in the device information 111 as a determination target information processor 10, and determines, on the basis of the connection type between the determination target information processor 10 and the local information processor 10, whether the determination target information processor 10 is positioned near to the local information processor 10.

Hereinafter, description will now be made in relation to a manner of determining whether a determination target information processor 10 is positioned near to the local information processor 10, which means whether a determination target information processor 10 is positioned within a predetermined range centering around the local information processor 10.

(a) when the determination target information processor 10 is wirelessly connected to the local information processor 10:

When the determination target information processor 10 is wirelessly connected to the local information processor 10, the searcher 102 determines that the determination target information processor is positioned near to the local information processor 10 if one of the following conditions (a1) to (a3) is satisfied.

(a1) when the determination target information processor 10 is connected to the same wireless access point that the local information processor 10 is connected, the searcher 102 determines that the determination target information processor is positioned near to the local information processor 10.

Determination whether the both information processors 10 is connected to the same access point can be made by referring to, for example, the IP address or the MAC address (see FIG. 4) of the gateway of the connection destination.

(a2) when the determination target information processor 10 is connected to the local information processor 10 via Wi-Fi Direct®, a short-range radio connection, the searcher 102 determines that the determination target information processor 10 is positioned near to the local information processor 10.

Determination whether the both information processors 10 are connected to each other via Wi-Fi Direct® can be made by using the network management function of the OS.

(a3) when the determination target information processor 10 is connected to the local information processor 10 via Bluetooth®, a short-range radio connection, the searcher 102 determines that the determination target information processor 10 is positioned near to the local information processor 10.

Determination whether the both information processors 10 are connected to each other via Bluetooth® can be made by referring to the connection type associated with a MAC address in the connection state managing information 112 (see FIG. 4).

In cases where any of the above conditions (a1)-(a3) is not satisfied even when the determination target information processor 10 is wirelessly connected to the local information processor 10, the searcher 102 determines that the determination target information processor 10 is not positioned near to the local information processor 10.

(b) when the determination target information processor 10 is wiredly connected to the local information processor 10:

When the determination target information processor 10 is wiredly connected to the local information processor 10, the searcher 102 determines that the determination target information processor is positioned near to the local information processor 10 if one of the following conditions (b1) and (b2) is satisfied.

(b1) when the determination target information processor 10 is directly connected to the local information processor 10 via a cross cable, the searcher 102 determines that the determination target information processor 10 is positioned near to the local information processor 10.

Determination whether the determination target information processor 10 is directly connected to the local information processor 10 can be made by referring to, for example, the IP addresses of the determination target information processor 10 and the local information processor 10 or the Time To Live (TTL) of bidirectional network communication (IP).

(b2) when the determination target information processor 10 is connected to the same router (not illustrated) that the local information processor 10 is connected, the searcher 102 determines that the determination target information processor is positioned near to the local information processor 10.

Determination whether the both information processors 10 is connected to the same router can be made by referring to, for example, the IP address or the MAC address of the connection destination or the IP address or the MAC address of the gateway.

In cases where any of the above conditions (b1)-(b2) is not satisfied even when the determination target information processor 10 is wiredly connected to the local information processor 10, the searcher 102 determines that the determination target information processor 10 is not positioned near to the local information processor 10.

The searcher 102 determines, by confirming the connection state between the determination target information processor 10 and the local information processor 10 in the above manners, whether the determination target information processor 10 is positioned near to the local information processor 10. Specifically, the searcher 102 indirectly determines the distance between the local information processor 10 and the determination target information processor 10 by determining whether the connection state between the local information processor 10 and the determination target information processor 10 satisfies any one of the above conditions (a1)-(a3), (b1), and (b2).

In other words, when one of the above conditions (a1)-(a3), (b1), and (b2) is satisfied, the searcher 102 determines that the determination target information processor 10 is positioned within the predetermined range from the local information processor 10, which means that the determination target information processor 10 is positioned near to the local information processor 10.

The searcher 102 can determine whether the determination target information processor 10 is positioned within the predetermined range from the local information processor 10 by confirming the connection state between the local information processor 10 and the determination target information processor 10, eliminating the need for a distance measure.

The logging-on user confirmer 103 confirms a user being logging on another information processor 10 by transmitting an inquiry request for a user being logging on the other information processor 10.

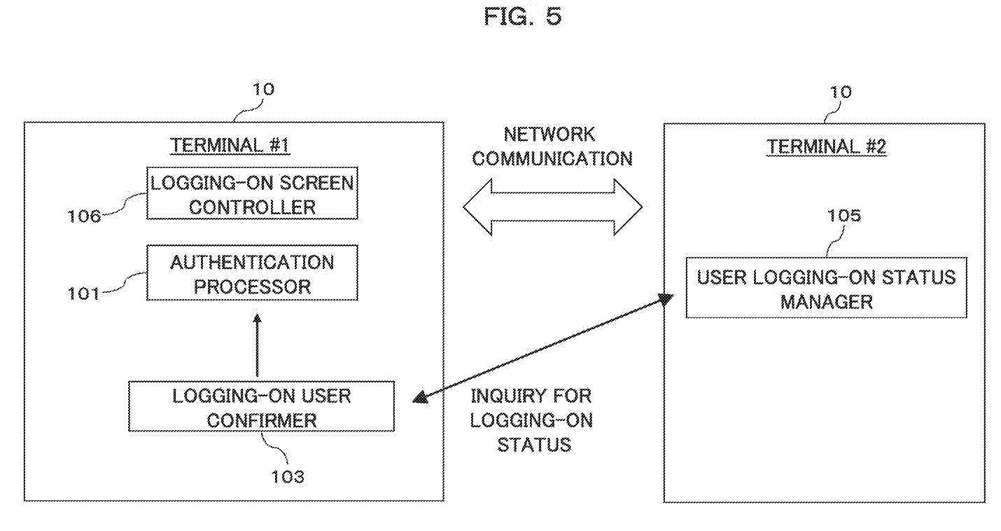

FIG. 5 is a diagram illustrating a process performed by the logging-on user confirmer 103 of the computer system 1 of the first embodiment.

FIG. 5 illustrates an example where the logging-on user confirmer 103 of the terminal #1 inquires the user logging-on status manager 105 of a terminal #2 of a user being logging on the terminal #2.

The logging-on user confirmer 103 receives a user ID of the user being logging on from the user logging-on status manager 105 of the terminal #2, and notifies the authentication processor 101 and the logging-on screen controller 106 of the received ID.

As illustrated in FIG. 5, the logging-on user confirmer 103 can inquire whether a user has already logged on or an account that has already logged on through, for example, one-to-one communication with another information processor 10.

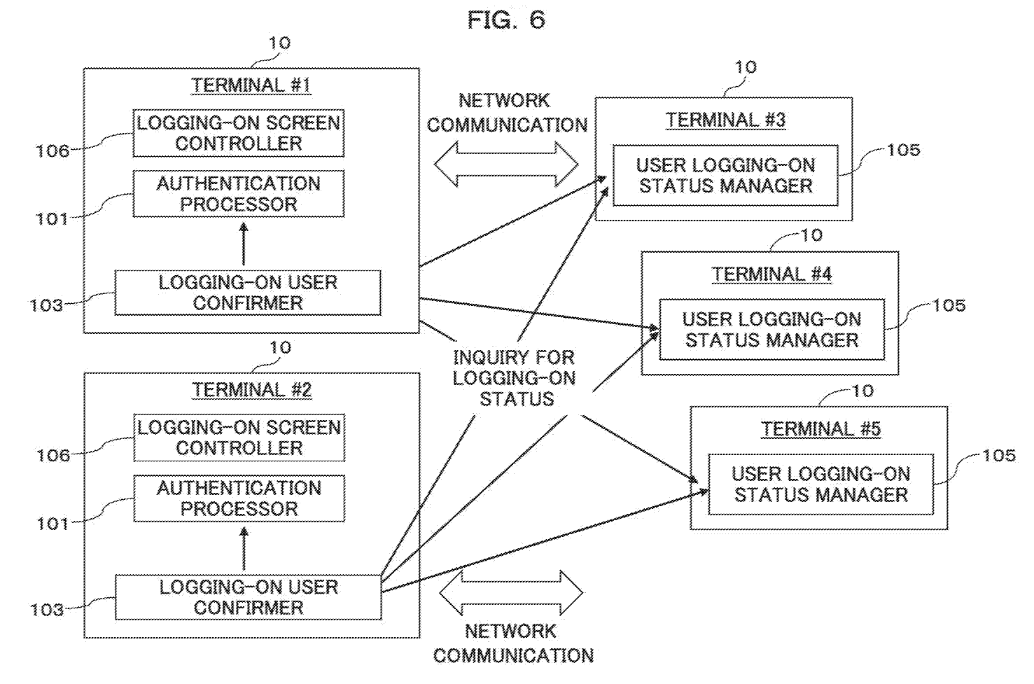

FIG. 6 is a diagram illustrating a process performed by the logging-on user confirmer 103 of the computer system 1 of the first embodiment. FIG. 6 illustrates an example where multiple (two in the example of FIG. 6) terminals #1, #2 each inquire the user logging-on status manager 105 of each of the multiple (three in the example of FIG. 6) terminals #3-#5 of a user being logging on the corresponding terminal 10.

Alternatively, the logging-on user confirmer 103 can inquire multiple other information processors 10 of whether a user has already logged on or an account that has already logged on the information processors 10 through broadcast communication.

The authentication processor 101 authenticates a user that is to use the local information processor 10.

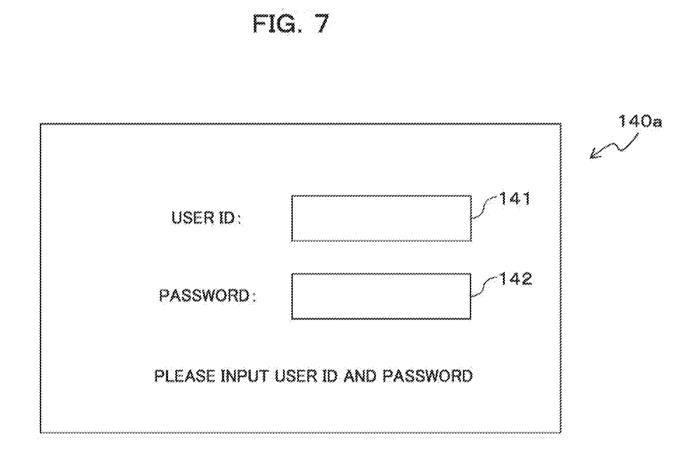

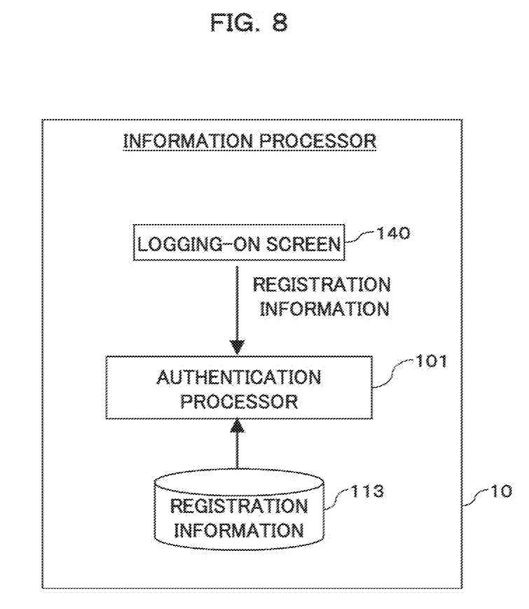

FIG. 7 is a diagram illustrating a logging-on screen 140a on the information processor 10 of the first embodiment, and FIG. 8 is a diagram illustrating a process performed by the authentication processor 101 of the information processor 10 of the first embodiment.

The logging-on screen 140a of FIG. 7 is an input screen that encourages the user in inputting a user ID identifying the user and the password to authenticate the password, and is displayed on the display 14 when, for example, the information processor 10 is started and a logging-on process is carried out.

The logging-on screen 140a includes an entry field 141 to input a user ID and an entry field 142 to input a password.

As illustrated in FIG. 8, the authentication processor 101 obtains the user ID and the password (collation information) that the user has input on the logging-on screen 140a of FIG. 7 with a non-illustrated input device such as a keyboard or a mouse.

The authentication processor 101 obtains registration information (registered password) 113 previously stored in, for example, the storage device in association with the user ID of a user to be authenticated.

Then the authentication processor 101 compares (collates) the collation information input on the logging-on screen 140a with the registration information 113.

If the input password matches the registered password, the authentication processor 101 determines (authenticates) that the user having been input the password is a valid user (i.e., a user with the valid identity). The authentication by the authentication processor 101 may be accomplished various known manners, the detailed description for which is omitted here.

As the above, the authentication processor 101 collates the user and if the collation result determines that the user is a valid user, sets the user to be in an authenticated state. For example, if determining, in the collation, that the user is a valid user, the authentication processor 101 sets, for example, “1” in an authentication flag representing whether the person to be authenticated is a valid user in the memory 12 or the storage device 13.

Under a circumstance where a user deals with multiple information processors 10 in his/her own home, the others does not use the information processors 10 and therefore it can be assumed that the same person uses these information processors 10, as the above.

Considering the above, when an information processor 10 that the user to be authenticated is being logging on is positioned near to the local information processor 10, the authentication processor 101 carries out simplified logging-on authentication on this user to be authenticated.

Namely, the authentication processor 101 functions as an authentication simplifier that simplifies, when another information processor 10 that the user has already logged on is positioned near to the local information processor 10, the authentication to be carried out by the authentication processor 101.

Here, the simplified logging-on authentication means that simplifying an input operation that the user makes to logging-on authentication.

Specifically, simplifying the input operation may, for example, reduce the number of digits of the collation information (password) that the user has to input or reduce the number of times of inputting the collation information. Further, the simplification may omit inputting of the password itself. The first embodiment describes an example where the authentication processor 101 omits inputting of the password to achieve the simplified logging-on authentication.

When the logging-on user confirmer 103 confirms the presence of a user being logging on another information processor 10 that the searcher 102 has determined to be located near to the local information processor 10, the authentication processor 101 sets the user being logging on to be the authenticated state without compelling the user to input the password into the local information processor 10.

The authentication of user by the authentication processor 101 is not limited to one using a password, and can be variously modified. Alternatively, the authentication processor 101 may further include an input sensor to input biometrics information such as fingerprint, palmprint, or iris, and may carry out biometrics authentication using the biometrics information input with the input sensor. The manner of authentication can be variously modified.

In the example of FIG. 8, the registration information 113 is stored in, for example, the storage device 13 of the information processor 10, but the storing destination is not limited to this.

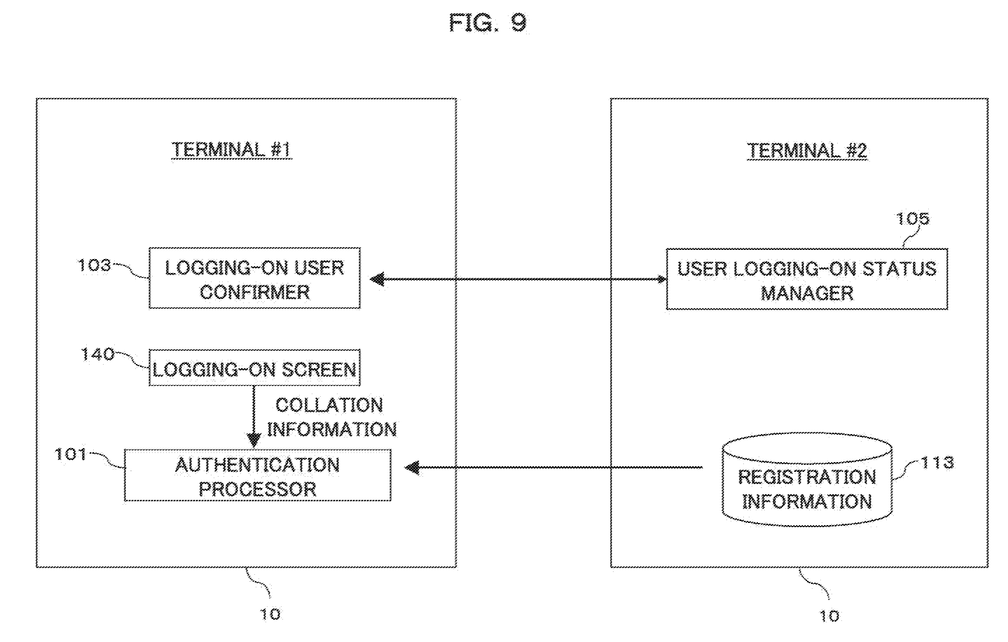

FIG. 9 is a diagram illustrating a modification to the process performed by the authentication processor 101 of the information processor 10 of the first embodiment.

In the example of FIG. 9, the registration information 113 is stored in the terminal #2, and the authentication processor 101 of the terminal #1 obtains the registration information 113 from the terminal #2 and authenticates a user using the obtained registration information 113.

As the above, the registration information 113 may be stored in the local information processor 10 or in another information processor 10. Further alternatively, the computer system 1 may further include a non-illustrated management server to manage the registration information 113, and various other changes and modifications can be suggested.

As illustrated in FIG. 8, storing the registration information 113 in the local information processor 10 can advantageously maintain the security of the registration information 113 because the registration information 113 does not flow through the network 50.

In contrast, storing the registration information 113 in a desktop information processor or a management server but not storing the registration information 113 in a mobile terminal device having a possibility of being stolen or lost can maintain the security of the registration information 113.

The logging-on screen controller 106 carries out control of switching a logging-on screen displayed on the display 14 in accordance with the result of searching an information processor 10 by the searcher 102 or the result of confirming by the logging-on user confirmer 103.

For example, if the searching by the searcher 102 results in that no information processor is positioned near to the local information processor 10, the logging-on screen controller 106 displays the logging-on screen 140a of FIG. 7 on the display 14.

In contrast, if the searching by the searcher 102 results in that another information processor 10 is positioned near to the local information processor 10 and also the confirming by the logging-on user confirmer 103 results in that a user is logging on the other information processor 10, the logging-on screen controller 106 displays an easy logging-on screen.

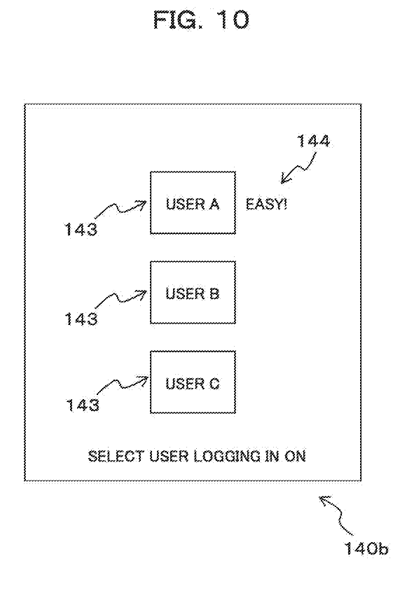

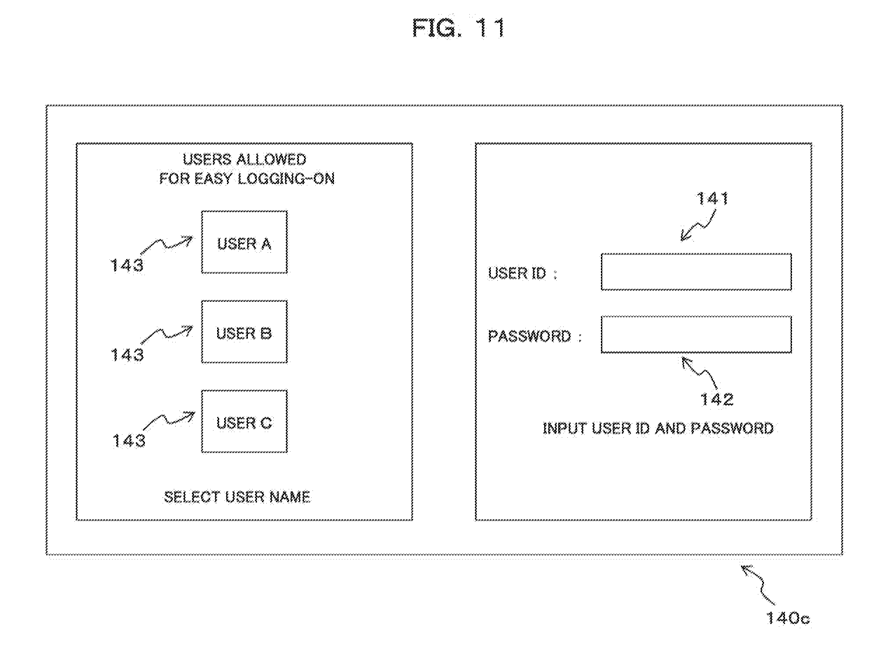

FIGS. 10 and 11 are each illustrating an example of an easy logging-on screen of the computer system 1 of the first embodiment.

The easy logging-on screen 140b of FIG. 10 includes aligned user icons 143 corresponding one to each of one or more (three in the example of FIG. 10) users. Among the three user icons 143, simplification notifying information 144 indicating that the logging-on authentication can be simplified is attached to a user icon 143 representing a user (USER A in the example of FIG. 10) being logging on another information processor 10 positioned near to the local information processor 10.

In the example of FIG. 10, the simplification notifying information 144 takes a form of a character string “EASY!”.

The user A represented by the user icon 143 with the simplification notifying information 144 is being logging on a near information processor 10 and will undergo simplified logging-on authentication by the authentication processor 101 to log on the local information processor 10.

This means that, if the user selects this user icon 143 attached thereto the simplification notifying information 144, the user is allowed to log on the local information processor 10 for future use without inputting the password.

The simplification notifying information 144 in the example of FIG. 10 is a character string of “EASY!”, but is not limited to this. Alternatively, the simplification notifying information 144 may be a different character string or a diagram, and the color or a shape of the user icon 143 and also be changed to indicate the simplification notifying information 144. Accordingly, various changes and modifications can be suggested.

A easy logging-on screen 140c of the example of FIG. 11 includes aligned user icons 143 corresponding one to each of the users (USERS A, B, and C in the example of FIG. 11) being logging on another information processor 10 as users allowed for easy logging-on. Likewise the logging-on screen 140a of FIG. 7, the easy logging-on screen 140c includes the entry field 141 to input a user ID and the entry field 142 to input a password.

When the user icons 143 arranged for the users allowed for easy logging-on do not include the user that is to log on, the user inputs the user ID and the password into the entry fields 141 and 142, respectively, to undergo authentication by the authentication processor 101.

The logging-on processor 104 controls a logging-on process of the user directed to the local information processor 10.

For example, as a result of the user authentication by the authentication processor 101 described above, if the use having undergone the authentication is a valid user, the functions of the local information processor 10 are made effective so that the local information processor 10 is moved into an operable state.

The user logging-on status manager 105 manages a user being logging on the local information processor 10. Further, upon receipt of an inquiry request for a user being logging on the local information processor 10 from another information processor 10, the user logging-on status manager 105 replies with the request with information about the user being logging on the local information processor 10.

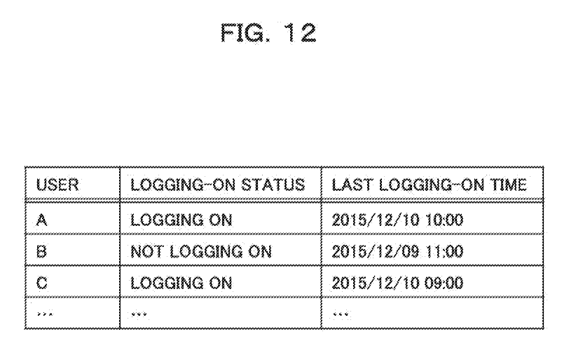

FIG. 12 is a diagram illustrating information about users being logging on which information is managed by the user logging-on status manager 105 of the computer system 1 of the first embodiment.

As illustrated in FIG. 12, the user logging-on status manager 105 manages the logging-on status and the last logging-on time and date of each of multiple uses (logging-on accounts) registered in the information processor 10.

Through managing the above information, the user logging-on status manager 105 can grasp the user being logging on the local information processor 10. With this configuration, upon receipt of an inquiry request for a user being logging on the local information processor 10 from the logging-on user confirmer 103 of another information processor 10, the user logging-on status manager 105 can reply to the request with information about a user being logging on the local information processor 10.

In relation to determination whether a user is logging on, the user may be determined to be logging on only while the user account is actually logging on. Alternatively, the user may be determined to be logging on for a predetermined time period since the user account has logged on even if the user has already logged off.

### (B) Operation

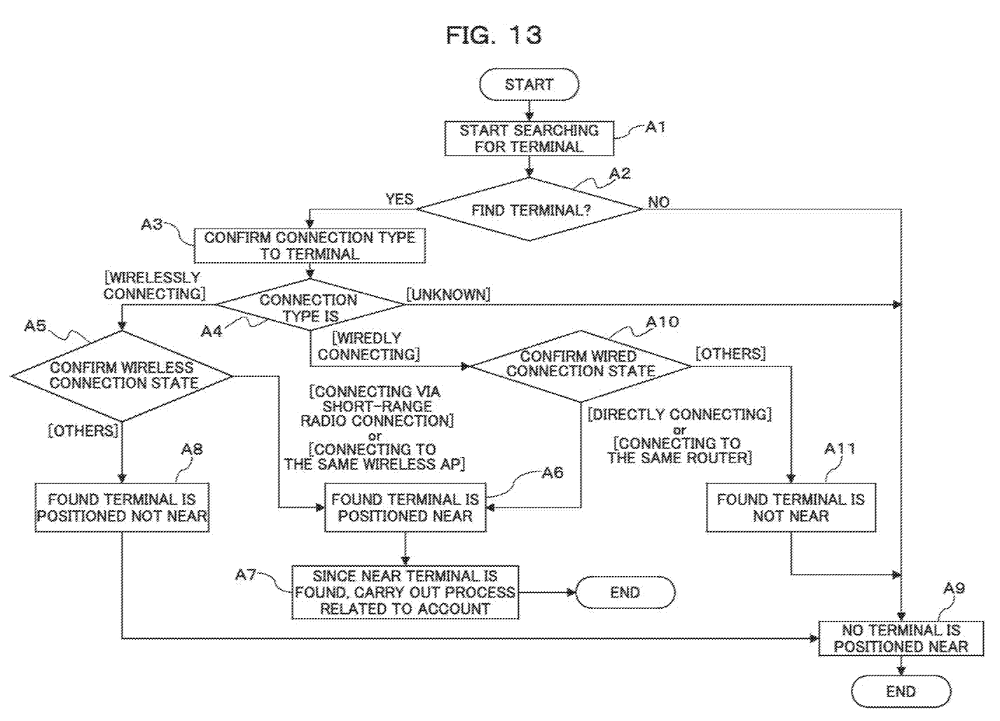

The description will now be made in relation to a manner of searching a near information processor 10 by the searcher 102 of the above computer system 1 of the first embodiment along the flow diagram (steps A1-A11) of FIG. 13.

In step A1, the searcher 102 start searching for terminals 10 connected through the network 50.

For example, the searcher 102 issues an information collecting command to collect information to another information processor 10 through the network 50 in order to search for the other information processor 10 connected to the local information processor 10 through the network 50.

The searcher 102 confirms whether another information processor 10 is found as a result of searching (step A2), and if another terminal 10 is found (see YES route in step A2), the process moves to step A3.

In step A3, the searcher 102 confirms the connection type between the local information processor 10 and the found terminal 10, that is, the determination target information processor 10.

As a result of confirming the connection type (step A4), when the local information processor 10 is wirelessly connected to the determination target information processor 10 (see [WIRELESSLY CONNECTING] route of step A4), the process moves to step A5.

In step A5, the searcher 102 refers to, for example, the connection state managing information 112 (see FIG. 4) to confirm the wireless connection state between the local information processor 10 and the determination target information processor 10.

As a result of the confirmation, if the local information processor 10 is connected to the determination target information processor 10 via a short-range radio connection (see the [CONNECTING VIA SHORT-RANGE RADIO] route or the [CONNECTING TO THE SAME WIRELESS AP] route of step A5), the process moves to step A6.

In step A6, the searcher 102 determines that the determination target information processor 10 is positioned near to the local information processor 10.

As the above, since the searcher 102 finds another terminal 10 positioned near to the local information processor 10, a logging-on process related to the user account is carried out in step A7 and the process ends. The logging-on process will be detailed below.

As a result of the confirmation of step A5, the local information processor 10 is not connected to the determination target information processor 10 via a short-range radio or is not connected to the same wireless AP (see [OTHERS] route in step A5), the process moves to step A8.

In step A8, the searcher 102 determines that the determination target information processor 10 is not a terminal 10 positioned near to the local information processor 10, and the process then moves to step A9.

In step A9, the searcher 102 determines that no another terminal 10 is positioned near to the local information processor 10 and ends the process.

In contrast, as a result of confirming in step A4, when the local information processor 10 is wiredly connected to the determination target information processor 10 (see [WIREDLY CONNECTING] route of step A4, the process moves to step A10.

In step A10, the searcher 102 confirms the state of wired connection between the local information processor 10 and the other terminal 10 with reference to, for example, the connection state managing information 112.

As a result of the confirmation, if the local information processor 10 is connected directly to the determination target information processor 10 or is connected to the same router that the determination target information processor 10 is connected to (see the [DIRECTLY CONNECTING] route or the [CONNECTING TO THE SAME ROUTER] router of step A10), the process moves to step A6.

In contrast, as a result of the confirmation in step A10, if the local information processor 10 is not connected directly to the determination target information processor 10 or is not connected to the same router that the determination target information processor 10 is connected to (see [OTHERS] route of step A10), the process moves to step A11.

In step A11, the searcher 102 determines that the determination information processor 10 is not positioned near to the information processor 10, and then the process moves to step A9.

If another terminal 10 is not found (NO route in step A2) as a result of the confirmation in step A2, the process also moves to step A9.

In addition, if the connection type between the local information processor 10 and the determination target information processor 10 is unknown despite the confirmation in step A4 (see the [UNKNOWN] route in step A4), the process moves to step A9.

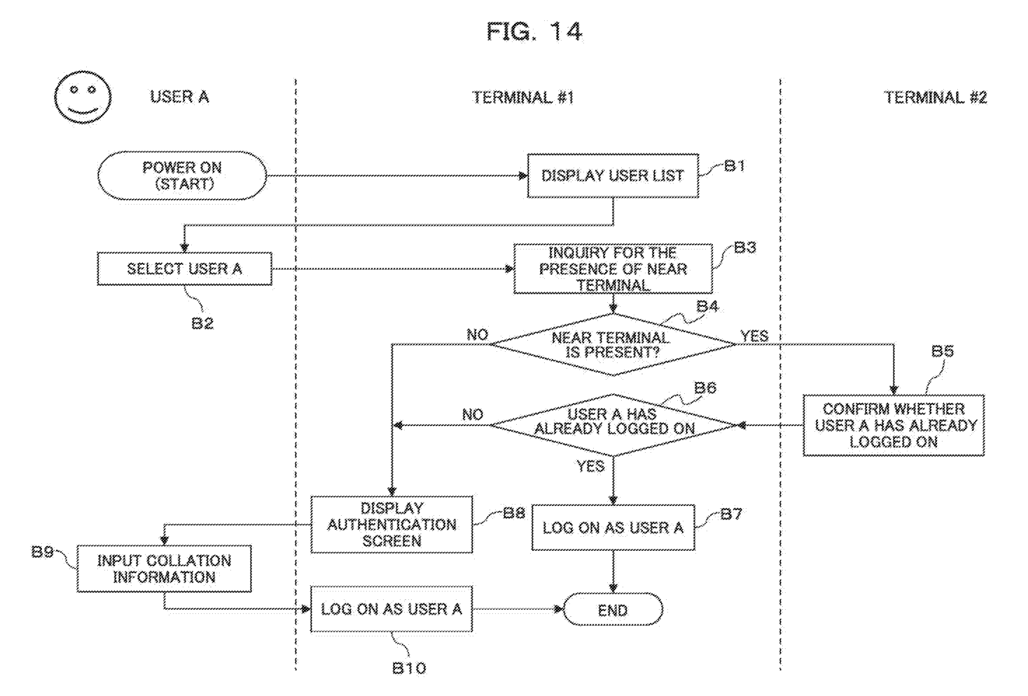

Next, description will now be made in relation to the method for controlling logging on when the information processor 10 is started in the computer system 1 of the first embodiment along a flow diagram (steps B1-B10) of FIG. 14.

FIG. 14 assumes an example where the information processor 10 (terminal #1) is shared by multiple users and the user A, one of the users, is to be authenticated to log on the terminal #1.

When the user A switches on (powers on) the terminal #1, the logging-on screen controller 106 displays a logging-on screen having a list containing icons of users allowed to log on the local information processor 10 (terminal #1) on the display 14 in step B1.

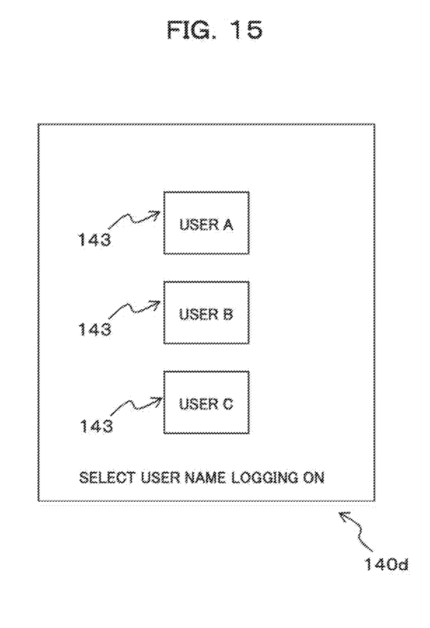

FIG. 15 is a diagram illustrating an example of a logging-on screen 140d having a list containing icons of users allowed to log on an information processor 10 in the computer system 1 of the first embodiment.

In the logging-on screen 140d of FIG. 15, the icons 143 representing user A, B, and C are aligned.

In step B2, the user A selects the icon 143 corresponding to the user A on the logging-on screen 140d.

In step B3, the searcher 102 of the terminal #1 inquires the presence of a terminal 10 positioned near to the local information processor 10 by issuing an information collecting command.

The searcher 102 determines whether another information processor 10 is positioned within a predetermined range centering around the local information processor 10 on the basis of the information from other information processors 10 in response to the information collecting command (step B4).

As a result of the determination, when another information processor 10 (in the example of FIG. 14, the terminal #2) is positioned near to the local information processor 10 (see YES route in step B4), the process moves to step B5.

In step B5, the logging-on user confirmer 103 of the terminal #1 issues, to the terminal #2, an inquiry for a user that has already logged on the terminal #2 for confirmation.

The user logging-on status manager 105 of the terminal #2 responds to the terminal #1 with the user that has already logged on the terminal #2.

In step B6, the logging-on user confirmer 103 confirms, on the basis of the response from the terminal #2, whether the user A has already logged on the terminal #2.

As a result of the confirmation, if the user A has already logged on the terminal #2 (YES route in step B6), the process moves to step B7.

In step B7, the logging-on processor 104 of the terminal #1 carries out the logging-on process on the user A. Specifically, the logging-on processor 104 assumes that the user A is authenticated as the valid user A and makes the various functions in the local information processor 10 effective, so that the information processor 10 is made into an operable state. Then the process finishes.

As a result of the confirmation in step B4, if no other information processor 10 is positioned near to the local information processor 10 (see NO route in step B4), the process moves to step B8.

In addition, as a result of the confirmation in step B6, if the user A has not logged on the terminal #2 (see NO route in step B6), the process moves to step B8.

In step B8, the logging-on screen controller 106 of the terminal #1 displays, for example, the logging-on screen 140a on the display 14 of the local information processor 10. In step B9, the user A inputs the user ID and the password, as the collation information, into the respective entry fields 141 and 142 on the logging-on screen 140a displayed on the display 14.

In step B10, the authentication processor 101 of the terminal #1 authenticates the user by collating the collation information input on the logging-on screen 140a with the registration information 113. If the input password matches the registered password as a result of the authentication, the authentication processor 101 determines the user is the valid user and sets the user to be in an authenticated state.

The logging-on processor 104 carries out a logging-on process on user A directed to the local information processor 10 and makes each function of the local information processor 10 effective, so that the information processor 10 is made into an operable state. Then the process finishes.

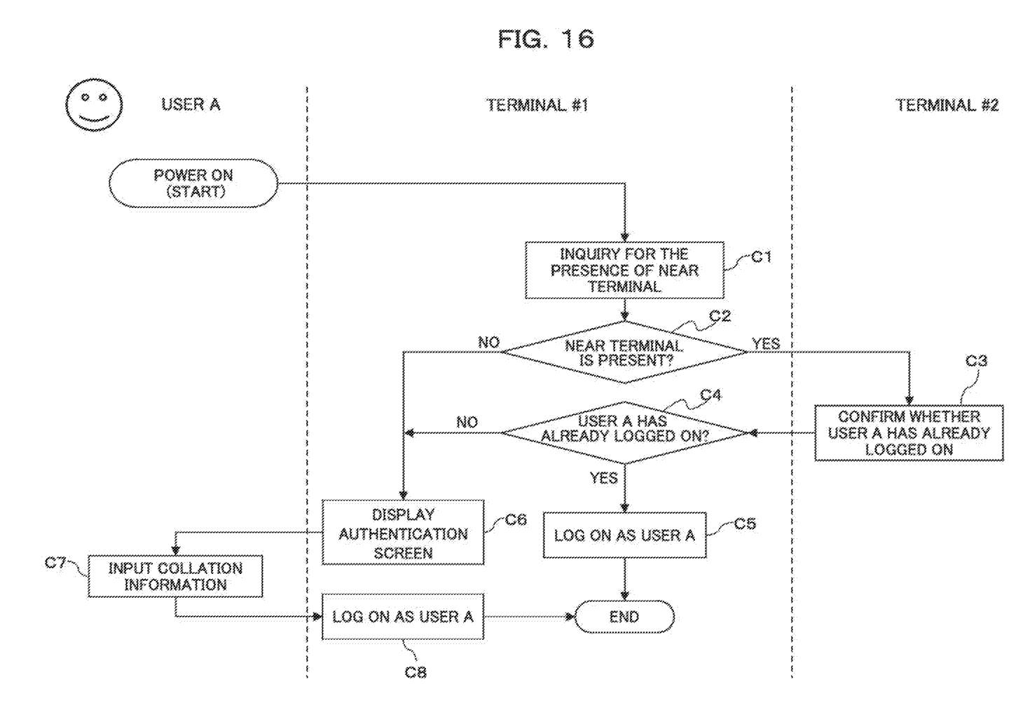

Here, description will now be made in relation to a first modification to the method for controlling logging on when the information processor 10 is started in the computer system 1 of the first embodiment along a flow diagram (step C1-C8) of FIG. 16.

The modification of FIG. 16 assumes an example where only user A uses the information processor 10 (terminal #1) and the user A is to be authenticated to log on the terminal #1. The steps C1-C8 of the flow diagram FIG. 16 are the same as the steps B3-B10 of the flow diagram FIG. 14, respectively.

Namely, when the user A switches on (powers on) the terminal #1, the searcher 102 of the terminal #1 inquires the presence of a terminal 10 positioned near to the local information processor 10 by issuing an information collecting command in step C1.

The searcher 102 determines whether another information processor 10 is positioned within a predetermined range centering around the local information processor 10 on the basis of the information from other information processors 10 in response to the information collecting command (step C2).

As a result of the determination, when another information processor 10 (in the example of FIG. 16, the terminal #2) is positioned near to the information processor 10 (see YES route in step C2), the process moves to step C3.

In step C3, the logging-on user confirmer 103 of the terminal #1 issues, to the terminal #2, an inquiry for a user that has already logged on the terminal #2 for confirmation.

The user logging-on status manager 105 of the terminal #2 responds to the terminal #1 with the user that has already logged on the terminal #2.

In step C4, the logging-on user confirmer 103 confirms, on the basis of the response from the terminal #2, whether the user A has already logged on the terminal #2.

As a result of the confirmation, if the user has already logged on the terminal #2 (YES route in step C4), the process moves to step C5.

In step C5, the logging-on processor 104 of the terminal #1 carries out the logging-on process on the user A. Specifically, the logging-on processor 104 assumes that the user A is authenticated as the valid user A and makes the various functions in the local information processor 10 effective, so that the information processor 10 is made into an operable state. Then the process finishes.

As a result of the confirmation in step C2, if no other information processor 10 is positioned near to the information processor 10 (see NO route in step C2), the process moves to step C6.

In addition, as a result of the confirmation in step C4, if the user A has not logged on the terminal #2 (see NO route in step C4), the process moves to step C6.

In step C6, the logging-on screen controller 106 of the terminal #1 displays, for example, the logging-on screen 140a on the display 14 of the local information processor 10. In step C7, the user A inputs the user ID and the password, as the collation information, into the respective entry fields 141 and 142 on the logging-on screen 140a displayed on the display 14.

In step C8, the authentication processor 101 of the terminal #1 authenticate the user by collating the collation information input on the logging-on screen 140a with the registration information 113. If the input password matches the registered password as a result of the authentication, the authentication processor 101 determines the user is the valid user and sets the user to be in an authenticated state.

The logging-on processor 104 carries out a logging-on process on user A directed to the local information processor 10 and makes each function of the local information processor 10 effective, so that the information processor 10 is made into an operable state. Then the process finishes.

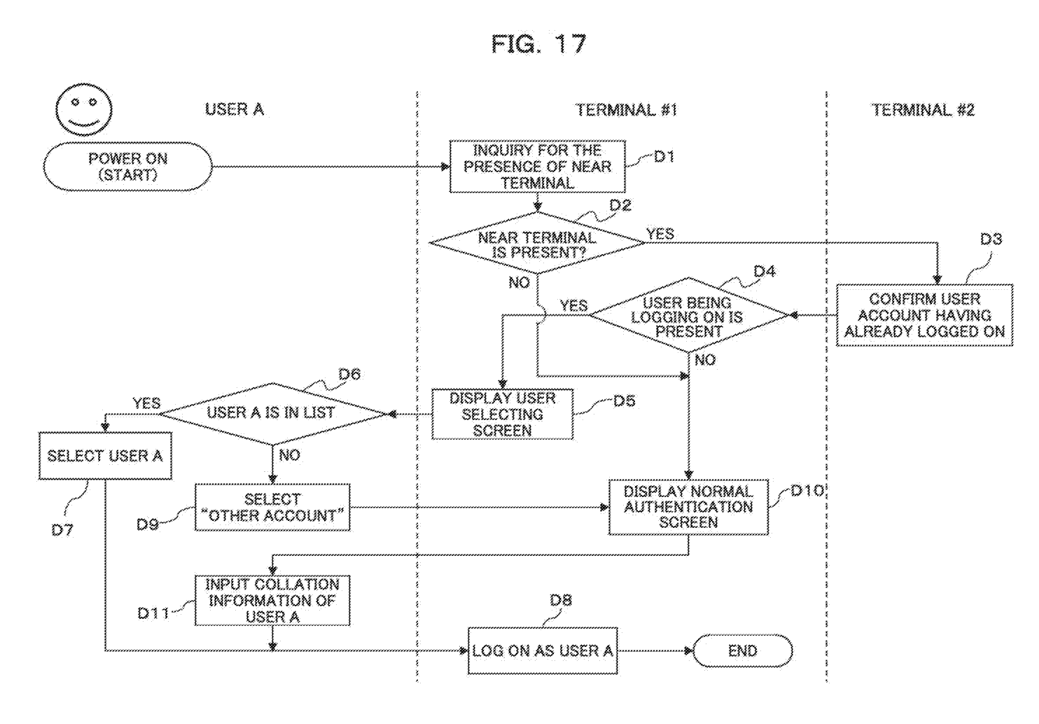

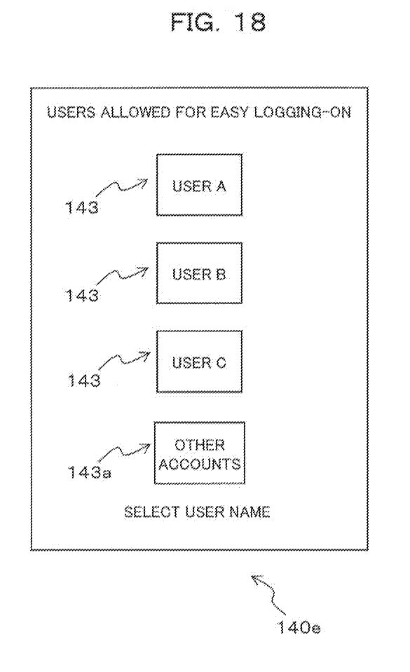

Here, description will now be made in relation to a second modification to the method for controlling logging on when the information processor 10 is started in the computer system 1 of the first embodiment along a flow diagram (step D1-D11) of FIG. 17 with reference to FIG. 18. FIG. 18 is a diagram illustrating a list representing users allowed for easy logging-on in the second modification to the computer system 1 of the first embodiment.

Also in the modification of FIG. 17, the information processor 10 (terminal #1) is shared by multiple users.

When the user A switches on (powers on) the terminal #1, the searcher 102 of the terminal #1 inquires the presence of a terminal 10 positioned near to the local information processor 10 by issuing an information collecting command in step D1.

The searcher 102 determines whether another information processor 10 is positioned within a predetermined range centering around the local information processor 10 on the basis of the information from other information processors 10 in response to the information collecting command (step D2).

As a result of the determination, when another information processor 10 (in the example of FIG. 17, the terminal #2) is positioned near to the information processor 10 (see YES route in step D2), the process moves to step D3.

In step D3, in the terminal #2, the user logging-on status manager 105 confirms the user account that has already logged on the local information processor 10, and notifies the logged-on user account to the logging-on user confirmer 103 of the terminal #1. Then the process moves to step D4.

In step D4, the logging-on user confirmer 103 of the terminal #1 confirms the presence of a user being logging on the terminal #2.

As a result of the confirmation, if a user being logging on the terminal #2 is present (see YES route in step D4), the logging-on screen controller 106 displays an easy logging-on screen 140e (see FIG. 18) on the display 14 in step D5.

In the easy logging-on screen 140e of FIG. 18, the user icons 143 corresponding to the users (in the example of FIG. 18, the users A-C) that has already logged on the terminal #2 are indicated to be users allowed for easy logging-on. In addition to the above, the easy logging-on screen 140e includes a user icon 143a for “other accounts” to allow another user except for the users A-C to log on the terminal #1.

In step D6, the user confirms whether a user icon of the user A is on the list in the easy logging-on screen 140e.

If the user A is on the list in the easy logging-on screen 140e as a result of the confirmation (see YES route in step D6), the process moves to step D7.

In step D7, the user A selects the user icon of the user A from the list on the easy logging-on screen 140e.

In step D8, the logging-on processor 104 of the terminal #1 carries out a logging-on process of the user A. Specifically, the logging-on processor 104 assumes that the user A is authenticated as the valid user A and makes the various functions in the local information processor 10 effective, so that the information processor 10 is made into an operable state. Then the process finishes.

As a result of the confirmation of step D6, if the user A is not on the list in the easy logging-on screen 140e as a result of the confirmation (see NO route in step D6), the icon 144 of “other accounts” is selected on the easy logging-on screen 140e (step D9). Then the process moves to step D10.

In step D10, the logging-on screen controller 106 of the terminal #1 displays the logging-on screen 140a of FIG. 7 on the display 14. Namely, the logging-on screen controller 106 displays the logging-on screen 140a in replace of the easy logging-on screen 140e. The logging-on screen 140a is regarded as a normal authentication screen not including icons of the user accounts allowed for easy logging-on.

After that, in step D11, the user A inputs the user ID and the password (collation information) into the entry fields 141 and 142, respectively, on the logging-on screen 140a, and the process moves to step D8.

In step D8, the logging-on processor 104 of the terminal #1 carries out the logging-on process on the user A. Specifically, the authentication processor 101 of the terminal #1 authenticates the user by collating the collation information input on the logging-on screen 140a with the registration information 113. If the input password matches the registered password as a result of the authentication, the authentication processor 101 determines the user is the valid user, and sets the user to be in an authenticated state.

The logging-on processor 104 carries out a logging-on process of user A directed to the local information processor 10.

As a result of the confirmation of step D2, if no information processor 10 (in the example of FIG. 17, terminal #2) is positioned near to the terminal #1 (see NO route of step D2), the process also moves to step D10.

In addition, as a result of the confirmation of step D4, if no user is logging on the terminal #2 (see NO route of step D4), the process also moves to step D10.

### (C) Effects

In the above computer system 1 of the first embodiment, if another information processor 10 is positioned near to an information processor 10 being performing a process of logging on and the same user is logging on the other information processor 10, the information processor 10 carries out a simplified logging-on authentication.

This can conveniently reduce a load of the user to input a complicated password for logging-on authentication in a logging-on process of the information processor 10.

For example, under the environment, such as a home, where there is no possibility that others uses the information processor 10 without any permission of the user, reducing a load of a complicated input on the user for logging-on authentication in a logging-on process of the information processor 10 is particularly effective.

In contrast, if another information processor 10 on which the same user is logging on is absent in the vicinity of the information processor 10 carrying out a logging-on process, the logging-on authentication of the information processor 10 is not simplified. This can ensure the security.

This can eliminate the possibility that a user using multiple terminals 10 is annoyed by workload on a strict authentication when the user is to use one of the information processors 10 in his/her home where no authentication is assumed to be needed. Consequently, the user does not resist to enable the security function when the user is going out, when strict authentication is needed, so that the security of the information processor 10 can be enhanced. This can ensures the both security and convenience.

When one of the above conditions (a1)-(a3), (b1), and (b2) is satisfied on the basis of the connection type of the determination target information processor 10 and the local information processor 10, the searcher 102 determines that the determination target information processor 10 is positioned near to the local information processor 10.

Specifically, when the determination target information processor 10 is connected to the same AP as the local information processor 10, when the determination target information processor 10 is wirelessly connected to the local information processor 10 by means of short-range radio connection, when the determination target information processor is wiredly connected directly to the local information processor 10, or when the determination target information processor 10 is wiredly connected to the same router as the local information processor 10, the searcher 102 determines that the determination target information processor 10 is positioned within a predetermined range from the local information processor 10.

This makes it possible determine whether another information processor 10 is positioned near to the local information processor 10 without hardware to measure the distance between the other information processor 10 and the local information processor 10.

### (D) Others

The present invention is by no means limited to the above embodiment and various changes and modifications can be suggested without departing from the gist of the present invention.

In the above first embodiment, the searcher 102 determines whether the determination target information processor 10 is positioned near to the local information processor 10 by determining whether one of the above conditions (a1)-(a3), (b1), and (b2) is satisfied. However, the determination is not limited to this.

In recent years, a router having functions of a wireless AP, a HUB of wired LAN, and a router has been used in home. The use of such a router cause the same network to have information processors 10 wirelessly connected and information processors 10 wiredly connected.

Considering the above circumstance, in cases where one of the local information processor 10 and the determination target information processor 10 is wiredly connected and the other is wirelessly connected, the satisfaction of the following condition (c1) determines that the determination target information processor 10 is positioned near to the local information processor 10.

(c1) when a gateway of the connection destination of a determination target information processor 10 is the same as that of the local information processor 10 is connected, the determination target information processor 10 is determined to be positioned near to the local information processor 10.

For the information processor 10 wirelessly connected, the IP address and the MAC address of the gateway of the connection destination are checked in the manner described in the above condition (a1). For the information processor 10 wiredly connected, the IP address and the MAC address of the connection destination, and the IP address and the MAC address of the gateway of the connection destination are checked in the manner described in the above condition (b1). The above manners make it possible to determine where the IP address and the MAC address of the gateway of the connection destination are the same.

When one of the above conditions (a1)-(a3), (b1), (b2), and (c1) is satisfied, the searcher 102 determines that the determination target information processor 10 is positioned within the predetermined range from the local information processor 10, which means that the determination target information processor 10 is positioned near to the local information processor 10.

In the above embodiment, when the determination target information processor 10 is connected to the same AP as the local information processor 10, when the determination target information processor 10 is wirelessly connected to the local information processor 10 by means of short-range radio connection, when the determination target information processor 10 is wiredly connected directly to the local information processor 10, or when the determination target information processor 10 is wiredly connected to the same router as the local information processor 10, the searcher 102 determines that the determination target information processor 10 is positioned within a predetermined range of the local information processor 10. However, the determination is by no means limited to this.

Alternatively, the information processor 10 may include a non-illustrated distance measure, and whether the determination target information processor 10 is positioned within a predetermined range from the information processor 10 may be made on the basis of the distance to the determination target information processor 10 measured by the distance measure.

A person ordinary skilled in the art can carry out and produce the embodiment with reference to the above disclosure.

The above first embodiment can lower the load of inputting operation for logging-on authentication made by the user.

All examples and conditional language recited herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. An information processor comprising:
an authentication processor that authenticates a user during a logging-on process of the user;
a confirmer that confirms whether a second information processor that the user has already logged on is present within a predetermined range from the information processor; and
an authentication simplifier that simplifies, when the second information processor that the user has already logged on by the user is present, the logging-on process carried out by the authentication processor.

2. The information processor according to claim 1, wherein the confirmer comprises a searcher that searches the second information processor being present within the predetermined range by confirming a connection state between the information processor and the second information processor.

3. The information processor according to claim 1, further comprising a manager that manages a user being logging on the information processor and notifies, upon receipt of an inquiry for a user being logging on from a third information processor, information about the user being logging on the information processor to the third information processor.

4. The information processor according to claim 1, wherein
one or more second users being logging on the second information processor is listed during the logging-on process of the user; and
the authentication simplifier simplifies a process of authenticating a user selected from the second users listed.

5. The information processor according to claim 1, wherein the authentication simplifier simplifies the logging-on process carried out by the authentication processor by omitting the logging-on process.

6. A method for controlling logging on an information processor, the method comprising:
authenticating a user during a logging-on process of the user;
confirming whether a second information processor that the user has already logged on is present within a predetermined range from the information processor; and
simplifying, when the second information processor that the user has already logged on by the user is present, the logging-on process carried out in the authenticating.

7. The method according to claim 6, further comprising searching the second information processor being present within the predetermined range by confirming a connection state between the information processor and the second information processor.

8. The method according to claim 6, further comprising:
managing a user being logging on the information processor; and
notifying, upon receipt of an inquiry for a user being logging on from a third information processor, information about the user being logging on the information processor to the third information processor.

9. The method according to claim 6, further comprising:
listing one or more second users being logging on the second information processor during the logging-on process of the user; and
simplifying a process of authenticating a user selected from the second users listed.

10. The method according to claim 6, further comprising simplifying the logging-on process carried out by the authentication processor by omitting the logging-on process.

11. A non-transitory computer-readable recording medium having stored therein a program for controlling logging on an information processor, the program causing a computer to execute a process comprising:
authenticating a user during a logging-on process of the user;
confirming whether a second information processor that the user has already logged on is present within a predetermined range from the information processor; and
simplifying, when the second information processor that the user has already logged on by the user is present, the logging-on process carried out in the authenticating.

12. The non-transitory computer-readable recording medium according to claim 11, the process further comprising searching the second information processor being present within the predetermined range by confirming a connection state between the information processor and the second information processor.

13. The non-transitory computer-readable recording medium according to claim 11, the process further comprising:
managing a user being logging on the information processor; and
notifying, upon receipt of an inquiry for a user being logging on from a third information processor, information about the user being logging on the information processor to the third information processor.

14. The non-transitory computer-readable recording medium according to claim 11, the process further comprising:
listing one or more second users being logging on the second information processor during the logging-on process of the user; and
simplifying a process of authenticating a user selected from the second users listed.

15. The non-transitory computer-readable recording medium according to claim 11, the process further comprising simplifying the logging-on process carried out by the authentication processor by omitting the logging-on process.
